(19) United States
(12) Patent Application Publication
(10) Pub. No.: US 2007/0084501 A1
(43) Pub. Date: Apr. 19, 2007

(54) Flexible solar power module with a current lead integrated in the frame

(76) Inventors: Klaus Kalberlah, Berlin (DE); Klaus Schlemper, Berlin (DE); Ing. Hubert Ehbing, Rothental-Erberich (DE); Frank Schauseil, Leverkusen (DE)

Correspondence Address: PEARL COHEN ZEDEK, LLP;PEARL COHEN ZEDEK LATZER, LLP, 1500 BROADWAY 12TH FLOOR, NEW YORK, NY, 10036, US

(21) Appl. No.: 11/482,110

(22) Filed: Jul. 7, 2006

(30) Foreign Application Priority Data
Jul. 7, 2005 (DE) 10 2005 032 716.8

(51) Int. Cl. H02N 6/00

(52) U.S. Cl. 136/245

(57) ABSTRACT

The invention refers to a non-glass and flexible solar power module and the method for its manufacture where the module is provided with a circumferential and flexible frame having integrated through-wiring and socket parts, which are formed face-side into the frame, for module interconnection by means of plug-in connectors. The solar module is thoroughly and completely sealed off on its rear side and has a full-surface smooth texture which is established by the insertion of a thin flexible panel, preferably made of plastic, together with the laminate into the form for the manufacture of the frame by means of RIM (reaction injection moulding). The modules are mounted on the building, preferably by means of bonding/cementing to practically any random roof materials, as well as to curved surfaces and without a backward cable lead.

### RELATED APPLICATION DATA

The present application claims priority from prior German patent application 10 2005 032 716.8, filed Jul. 7, 2005, incorporated by reference herein in its entirety.

### BACKGROUND OF THE INVENTION

Well over 90% of all solar power modules produced at present consist of “solar cells” which are covered off on one side with a pane of glass, on the other side with a special synthetic foil or with a further pane of glass. Such an embedding of solar cells is known as “laminate”. Provided with a frame that usually consists of aluminium profile in conjunction with a rear-side electrical connection, the laminate is transformed into the commercially available final product, a “solar module”. It is understandable that such modules are not flexible and are subsequently less suitable for building integration by means of a cementing process.

The term “foil module” designates the embedding of solar cells between two synthetic foils, and if required between a front-side translucent foil and a flexible sheet metal (aluminium or high quality steel) on the rear side. Such foil modules are limited with regard to flexibility. They are deployed preferably for camping applications and, due to lack of safety against heavy hailstorm, they can also not be used for building integration purposes.

A flexible foil module that uses crystalline silicon cells and is secure against heavy hailstorm was proposed in DE 103 56 690. In this case a “through-wiring” is envisaged but is, however, worked into the laminate. The printed patent specification DE 100 48 034 also envisages a through-wiring in a flexible module for roof integration by means of a cementing process (“BIPV-module”=building integrated photovoltaic module). However, in both cases there is no mention of a framing and the integration of the through-wiring into the frame.

Foil laminates “UNIsolar®” are unique worldwide, comprising an embedding of cells made of amorphous thin-layer silicon, vapour-deposited onto thin high-quality sheet metal steel between two synthetic foils. Subsequently, they are both flexible as well as secure against heavy hailstorm and are manufactured particularly for the cementing process with smooth roof materials such as steel sheet metal, titanium zinc sheet metal etc.

Such UNIsolar® laminates for the manufacture of “BIPV-installations” have been used for some years by THYSSEN-HOESCH and are being marketed under the name “Solartec®”. A framing of the laminates is not performed here; moreover, the “solar rolled mechandise” that is usually several meters in length is cemented in the factory onto the roof bands and, with a relatively work-intensive effort, is provided with a rear-side cable connection at least at one location per laminate, and this means an unavoidable breakthrough in the roof covering.

The cementing of the laminates onto the roof bands, which are up to 8 meters in length, is an unfavourable solution in principle because each roof band must be manufactured with individual adaptation (in length and colour etc.) in the factory of the manufacturer for the roof material. This is not only a consequence of the cementing technique (with a heating table 130° C. and EVA-fusion adhesive) but, above all, is subject to the rear-side electrical connecting configuration that cannot be performed to professional standards on the building as such.

The present BIPV technology as realised, for example, by HOESCH and RHEINZINK with the procurement of flexible UNIsolar® laminates therefore indicates some serious disadvantages: cementing and cable connection is performed in the factory and not on the construction site so that, in addition to the transport problem involving thin sheet metal profiles of up to 8 m in length, there is the difficulty of producing the whole roof “custom made” instead of selling standard merchandise on a mass basis. Normally, the roof material namely is delivered as rolled merchandise and the profile is manufactured directly at the construction site (e.g., “Profilomat”-technology of RHEINZINK). A further disadvantage is the fact that the electrical interconnecting of the numerous connecting points at the construction is comparatively work-intensive. Furthermore, there is a relatively great danger of damaging the sensitive solar technical equipment during transport and during the mounting of the roof bands (e.g., with the “Falzomat”-technology of Rheinzink).

A portion of the disadvantages as mentioned above is already solved more or less satisfactorily by the patent application DE 100 48 034. If, beyond this, a flexible framing of the laminates were to be used instead of a non-framed self-adhesive technique, then this would provide for decisive improvements:
a) “Edge protection” against delamination and against access of moisture, meaning, protection against cell degradation;
b) Additional insulation of live parts (Protection Class II Construction);
c) Uncomplicated integration of the module plug-in connector;
d) Precautions for durable cementing and sealing to the underlying subsurface
e) Use of a front-side protective foil with adhesion at the frame
f) Professional design; module also usable without self-adhesive.

The two applications U.S. Pat. No. 4,830,038 and U.S. Pat. No. 5,008,062 would seem to anticipate the idea of providing flexible solar laminates with a frame which was manufactured from synthetic material by means of RIM (reaction injection moulding). In actual fact, however, there are substantial differences:
a) The solar laminate to be enclosed according to the US patents is a glass panel, so that a flexible module cannot originate, and this is also not the task assignment of the patents. Moreover, the contrary is explicitly referred to here, meaning a stiffening and a protection of the glass panel (against fracture), respectively.
b) The US patents do not actually intend to have a framing but rather a complete enclosure of the glass-type laminate, a fact that explicitly includes the synthetic material coating of the rear side by means of RIM.
c) According to the US,patents the connecting lines between the solar cells and the module connection are embedded in the synthetic material. However, a through-wiring for the interconnection with adjacent modules is not mentioned with one single word.
d) The synthetic material as used for the RIM-method has unobjectionable adhesion on glass, and a laminate made of glass can also not deflect with the RIM-enclosure. For this reason, the task assignment upon which this invention is based in one of a completely different nature.

Furthermore, a method is known from EP 1 225 642 wherein solar modules with a frame and a rear side consisting of an elastomer polyurethane are provided with rear and surrounding foaming. The reaction injection moulding method (RIM) is adopted here preferably. The publication in question, however, does not describe that the solar modules have the feature according to the invention of being flexible. It is furthermore explicitly mentioned that “fastening parts” can be integrated in the frames. However, the integration of a through-wiring is not mentioned.

The integration of a through-wiring in the module frames is also not obvious for standard modules because they are not cemented on the rear side and/or they do not have to lie full-surface on any base. Normally and moreover, a rear-side connecting box and a cable connection to the adjacent modules is adopted.

It is furthermore envisaged according to EP 1 225 642 that, together with the frame, also the laminate rear side is at the same time covered off with a synthetic material layer. However, there is no mention of the fact that a rear-side covering of the laminate can be far more advantageously performed in such a way that the laminate before placing into the form for framing is already provided with this. The latter can also consist of a material other than that of the frame, as different from the simultaneous framing and rear foaming.

Tests with the intention of framing a flexible laminate of the trademark “UNIsolar®” according to the method described in EP 1 225 642 were not successful for two reasons:
(1) A Teflon®-foil is normally used for the front side of flexible solar modules in order to obtain dirt-repelling properties. This leads practically inevitably to a situation where a de-adhesion of the frame takes place on the front side, meaning, a durable moisture-proof sealing is not achieved due to the poor adhesion of the materials Teflon® and, for example, polyurethane.
(2) The rear-side coverage of the flexible laminate also leads unavoidably to a deflection of the laminate as a result of surrounding foaming with, for example, polyurethane. The cause of this is the fact that the synthetic material for the rear side shrinks during the RIM process and has a different thermal expansion reaction than the solar laminate. During the cooling of the laminate following the rear-side injection, the undesirable deflection of the finished module subsequently occurs.

### SUMMARY OF THE INVENTION

The invention refers to a non-glass and flexible solar power module and the method for its manufacture where the module is provided with a circumferential and flexible frame having integrated through-wiring and socket parts, which are formed face-side into the frame, for module interconnection by means of plug-in connectors. The solar module is thoroughly and completely sealed off on its rear side and has a full-surface smooth texture which is established by the insertion of a thin flexible panel, preferably made of plastic, together with the laminate into the form for the manufacture of the frame by means of RIM (reaction injection moulding). The modules are mounted on the building, preferably by means of bonding/cementing to practically any random roof materials, as well as to curved surfaces and without a backward cable lead.

An embodiment of the invention may include a flexible, non-glass solar module with a circumferential frame made of synthetic material which encloses the edges of the flexible laminate, wherein, the synthetic material frame has durable-elastic and flexible consistency and that, into this, a flat band-type through-wiring is formed which runs circumferentially in the immediate vicinity of the frame inner edge on the front side of the laminate and is solidly joined to this.

An embodiment of the invention may include a flexible solar module wherein, plug-in sockets are applied to the ends of the through-wiring and are formed into the frame.

An embodiment of the invention may include a method for the manufacture of a solar module wherein, the frame is produced according to the RIM-method (reaction injection moulding) where a flexible laminate in placed into the form for establishing the frame, after which flat band-type through-wirings were circumferentially and solidly joined on its front side and provided with plug-in sockets at the ends.

An embodiment of the invention may include a method for the manufacture of a flexible solar module wherein the solid connection of the band-type through-wiring at the laminate is effected by means of riveting and/or cementing, where metal washers can be added to the rivets underneath for the purpose of additional anchoring of the rear-side frame.

An embodiment of the invention may include a flexible solar module wherein a flexible and thin panel made of synthetic material or metal is used for the rear-side covering of the laminate.

An embodiment of the invention may include a method for the manufacture of a flexible solar module wherein, the rear-side panel is fixed-positioned on the rear side on the laminate before being placed into the form for establishing the frame with RIM.

An embodiment of the invention may include a flexible solar module wherein, the panel consists of PVC hard foam.

An embodiment of the invention may include a flexible solar module wherein, for the rear-side covering of the laminate, in place of the panel a layer consisting of weather-proof, closed-porous, soft and durable-elastic foam material is used.

An embodiment of the invention may include a method for the manufacture of a solar module wherein, the layer of foam material is cemented rear-side on the laminate before placing into the form for establishing the frame with RIM.

An embodiment of the invention may include a flexible solar module wherein, the thickness of this foam material layer is greater than the thickness of the frame on its underneath side.

An embodiment of the invention may include a flexible solar module wherein the foam material is provided on the rear side, either completely or partially, with a self-adhesive layer and is provided at those locations which are self-adhesive with a removable (peelable) protective foil.

An embodiment of the invention may include a flexible solar module wherein, a suitable adhesive agent for point-wise application on the module rear side is co-supplied with the module for the respective roof material.

An embodiment of the invention may include a flexible solar power module wherein on the rear side of the frame a circumferential seal consisting of durable elastic sealing material is applied, preferably in the form of a round cord made of butyl-caoutschouc with a protective foil that can be removed (peeled) on the building side.

An embodiment of the invention may include a flexible solar power module wherein, a circumferential hollow channel is formed into the frame on the underneath side for accommodating the seal.

An embodiment of the invention may include a flexible solar power module wherein, a butyl round cord with an inserted core, which brings the spacing of the module to the subsurface to a defined size, is used as a seal.

An embodiment of the invention may include a flexible solar power module wherein the frame receives securing holes which, at the corners of the frame at the locations of the overlapping of the band-type through-wiring, have full passage through these and are protected by means of synthetic sockets against weather conditions as well as against unintentional electric contact with fastening screws.

An embodiment of the invention may include a method for the manufacture of a flexible solar module wherein, before the inclusion of the laminate into the form for establishing the frame with RIM, the holes for the securing purposes are made all the way through the laminate and the overlapping of the through-wiring, and the sockets consisting of insulating synthetic material are positioned in the securing holes.

An embodiment of the invention may include a flexible solar power module wherein the front side facing the light is covered off with a protective foil in such a way that this, going beyond the laminate, partially covers the frame and uses the frame as an adhesive subsurface.

### DESCRIPTION OF THE DRAWINGS

The invention is explained as follows in greater detail on the basis of a principle drawing (FIG. 1) and three embodiment examples (FIG. 2-4).

FIG. 1 shows schematically a top view of the BIPV-module according to the invention.

FIG. 2 shows a cross-section through the frame of the BIPV-module without precautions for the roof cementing.

FIG. 3 shows the flexible laminate (2) with synthetic framing (1) where the front-side adhesion is again achieved by way of the copper band (3a) that is joined to the laminate by means of a suitable cement layer (3b).

FIG. 4 shows the flexible module according to the invention, similar to FIG. 2, however with additional precautions for cementing on old or difficult subsurfaces.

### DETAILED DESCRIPTION

This invention describes a method nevertheless for the purpose of framing flexible laminates, e.g., of the trademark “UNIsolar®” with a polyurethane by means of RIM-technology. The already mentioned disadvantages of the front-side de-adhesion and the deflection are in fact avoided where the through-wiring consisting preferably of a flat copper band is at first applied to the front side onto the Teflon® foil and is durably joined to the laminate by riveting and/or by a suitable and special cementing.

The frame on its part sticks securely to the copper band so that the disadvantageous de-adhesion of frame and laminate, as observed without through-wiring, does not occur.

Furthermore, the rear side of the laminate is provided with a covering before the manufacture of the frame, for example with a foamed or compact synthetic panel. This panel does not shrink or heat up during the framing process, so that there is no disadvantageous deflection of the laminate which occurs during the surrounding foaming of the rear side with frame material. At the same time a close adhesion is established during the RIM operation between the frame and the edge of the rear-side panel adjacent to the frame so that, on the one hand, a sufficient mechanical holding of the rear-side panel is ensured and, on the other hand, a reliable sealing against moisture is also ensured on the rear-side.

In this way, the enclosure of the rear side remains even then intact in a situation where the adhesion between panel and laminate rear side is non-existent or is unsatisfactory. As also in the case of the front-side adhesion, the cementing with the rear side of some laminates (e.g., of UNI-solar® laminates due to their Tedlar®-rear side) causes difficulties.

Instead of the rear-side panel consisting of foamed or compact synthetic material, a layer type structural configuration can also be adopted that makes the finished module self-adhesive on a durably elastic basis. For this purpose and as already proposed at an other place (DE 100 48 034), a closed-porous foam layer is suitable which is coated underneath with adhesive foil and covered with a removable (peelable) protective foil (e.g., silicon paper). If the laminate together with the described layer structural configuration is placed into the form for establishing the frame by means of RIM technology, a close bonding between frame and cutting edge of the rear-side foam material covering is formed here also. At the same time it is proposed to dimension the foam layer thicker than the underneath side of the frame so that, during the cementing process on the roof, the module is not lying on the frame but rather that the compensating function of the foam material can be effective.

The purpose of this invention, therefore, is firstly to modify the framing method for flexible laminates as presented in EP 1 225 642. In this case it is possible to set the stiffness of the synthetic material to a low level and to dispense with filler materials to the greatest possible extent so that the frame itself remains flexible. The latter is not obvious because the filler material content is set rather to a high level for glass laminates for adaptation of the thermal expansion coefficient and to avoid bending stresses, and the resulting stiffness of the frame is regarded as being an advantage.

Secondly, the problematic adhesion of the frame on the front side of the laminate is achieved by means of a “coupling agent” via through-wiring. There is undoubtedly an inventive step in the placement of the through-wiring, which otherwise runs within the laminate (refer to DE 103 56 690, FIG. 6) or on the laminate rear side (refer to DE 100 48 034, FIG. 2), circumferentially at the rim of the front side so that it assumes at that location the double function of an electric conductor and that of the “coupling agent”.

As the laminate rear side must be covered off over the full surface and must be protected against moisture, and then again a deflection as would occur with the simultaneous production of frame and rear side according to EP 1 225 642, U.S. Pat. No. 5,008,062 and U.S. Pat. No. 4,830,038 can not be accepted, a third inventive idea appears here. This inventive idea is to form the rear-side covering as an additional and finished part (panel or foam material layer) and to fix-position this before placing the laminate into the form for RIM surrounding foaming at the laminate rear side.

Of course, it would be possible to insert such a rear-side covering after establishing the frame. However, this means an additional processing step where the question of adhesion and sealing between panel and frame raises certain technological difficulties, even solely because of the dimension tolerances that are unavoidable with flexible solar laminates.

It is easily possible to provide the flexible module with the rear-side synthetic panel, as described, with a self-adhesive structural configuration in the follow-up. Preferably and for this purpose, a durable elastic seal is applied at first between module and base by means of butyl-caoutschouc and this is already done in the factory, circumferentially on the frame underneath side. Secondly, a reliable cementing is achieved by means of the application of a suitable cement on the builder's side, e.g., of an MS-polymer-cement which can be co-supplied as cartridge merchandise. At the construction site, therefore, the protective foil is first drawn off over the butyl-caoutschouc, then cement is applied at 4 to 6 locations on the synthetic panel, and finally the module is pressed onto the subsurface, for example also on concrete or bitumen roof courses. This sealing and adhesive technique (2 systems) is also suitable for already existing or difficult subsurface materials.

If the materials involved here are new, meaning if clean, dry and grease-free subsurface materials are used here, for example roof bands made of titanium zinc sheet metal (of RHEINZINK) or of coloured-lacquered aluminium (FALZONAL® of ALCAN), a sufficiently reliable and sealing cementing can also be achieved with a rear-side layer consisting of closed-porous foam material, coated with acrylate adhesive foil. The expenses for the rear-side and flexible synthetic panel can then be saved where, at its location, a self-adhesive structure with soft foam material is fixed-positioned on the rear side of the laminate and is placed into the form together with the laminate for the purpose of establishing the frame. However, and in order to utilise the elastic properties and subsequently to ensure an unobjectionable adhesion on the roof material, the self-adhesive foam material should have a greater thickness than that of the underneath side of the frame.

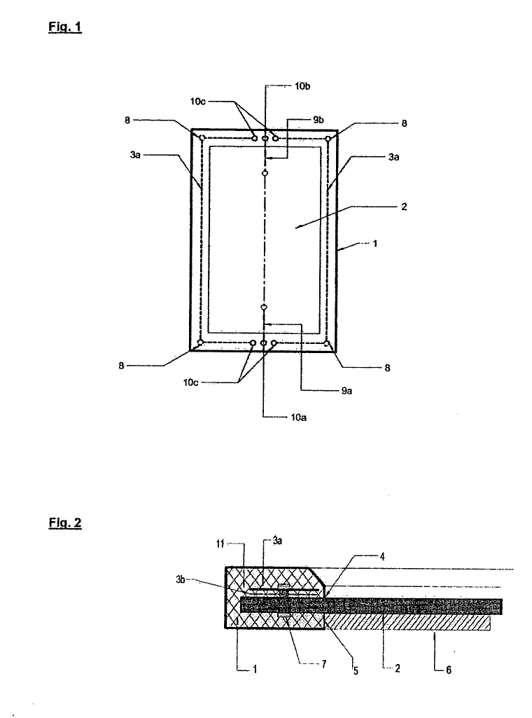

The invention is explained as follows in greater detail on the basis of a principle drawing (FIG. 1) and three embodiment examples (FIG. 2-4).

Following is a reference numbers list:
1=Synthetic framing
2=Flexible solar laminate
3a=Through-wiring (copper band)
3b=Special cementing
4=Potential water entry
5=Connection frame rear side
6=Hard foam panel
6a=Foam material layer
6b=Adhesive layer A
6c=Adhesive layer B
6d=Protective foil (removable on the building side)
7=Rivet connection
8=Synthetic socket
9a=Connection-wiring, plus
9b=Connection-wiring, minus
10a=Plug-in socket, plus
10b=Plug-in socket, minus
10c=Plug-in sockets, through-wiring
11=Tolerance=area
12a=Butylon—round cord
12b=Protective foil (removable on building side)
12c=Hollow channel, circumferential
13=Adhesive agent (cartridge merchandise, applied on building side).

FIG. 1 shows schematically a top view of the BIPV-module according to the invention. The flexible laminate (2) is surrounded with a flexible synthetic frame (1); the through-wiring (3a), that runs all round, is foamed into this and is not to be confused with the electrical connecting wiring of the cells (9a, 9b). Accordingly, 2 sockets for the module connection (10a, 10b) and 4 sockets for the plug-in connector of the through-wiring (10c) are shown. In the corners of the module frame there are 4 securing holes (8) which go through the flat band of the through-wiring (3a) but where, however, an electric contact is prevented in each case by a synthetic socket (not shown) inserted before the foaming process.

FIG. 2 shows a cross-section through the frame of the BIPV-module without precautions for the roof cementing. The flexible laminate (2) is surrounded by a flexible synthetic framing (1) where the front-side adhesion of the frame is achieved by way of the copper band of the through-wiring (3a) that is secured by rivets (7) with positive locking at the laminate (2) and is additionally fixed-positioned with adhesive tape (3b). The location of a potential water entry (4) lies in the immediate vicinity of the copper band (approx. 1 mm clearance) and is therefore durably sealed off. Any possible dimension tolerances in the width of the flexible laminate (2) are balanced out in the area (11) so that the frame clearance from the copper band is not influenced as a result of this.

On the rear side, the flexible laminate (2) is provided with a bendable PVC hard-foam panel (6). As the panel (6) together with the laminate was placed into the form for establishing the frame (by means of RIM), a close connection between frame (1) and panel (6) is ensured at that location (5).

FIG. 3 shows the flexible laminate (2) with synthetic framing (1) where the front-side adhesion is again achieved by way of the copper band (3a) that is joined to the laminate by means of a suitable cement layer (3b). On the rear side, the flexible laminate (2) was provided with a durable elastic foam material layer (6a) before placing into the form for establishing the frame, and fixed-positioned with adhesive foil (6b) to the laminate where the soft foam material layer (6a) has on its underneath side a suitable adhesive layer (6c) for joining with comparably new roof materials as well as the usual and removable (peelable) protective foil (6d). The thickness of the foam material layer (6a) here is greater than the thickness of the underneath side of the frame (2).

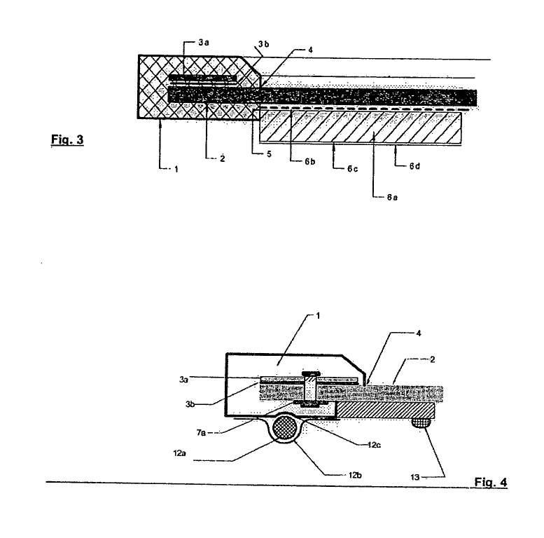

FIG. 4 shows the flexible module according to the invention, similar to FIG. 2, however with additional precautions for cementing on old or difficult subsurfaces. A circumferential groove (12c) is formed into the frame (1), and into this groove a sealing cord (12a) made of durably adhesive butyl-caoutschouc was located after the framing in the factory. The covering foil (12b) is removed on the building side before cementing the module, as also the individual adhesive points (13) are applied on the building side.

The secure connection of the through-wiring (3a) with the laminate (2) by means of rivets (7), as already known from FIG. 2, is supported by the underneath insertion of a washer (7a), for example made of aluminium), through which the polyurethane frame on the laminate underneath side receives additional points of the anchoring by means of the cementing effect with the washers.

The advantages of the product according to the invention compared with commercially available BIPV (e.g., Solartec® of THYSSEN) are that the module, with regard to randomly smooth as well as curved surfaces of building structures, for example on roofings or facade revetments,
(1) is applied on the building side, meaning, is also applied to already existing “old” building surfaces;
(2) is durably cementable on almost all subsurfaces, for example, also on concrete or bitumen roof courses;
(3) the electrical connection of the modules is contained in their frames and/or is established by means of plug-in connections on the roof upper side, so that breakthroughs of the roof skin are required on only very few locations;
(4) the object-related customised production of the solar roofing at the manufacturer's including its considerable transport expenditure is not required;
(5) the module undergoes a substantial quality upgrade (e.g., with regard to degradation, delamination, ground leakage etc.) because, with the framing, edge protection and a “de-coupling” of the rear-side sealing from the cementing with the sub-material is achieved;
(6) the module can be equipped with a front-side protective foil; as the protective foil does not have adhesion to the Teflon front side of the laminate, protective foil is not used up to the present and/or claim 7 in DE 100 48 034 cannot be realised without a frame.

1. A flexible, non-glass solar module comprising:
a circumferential frame comprising synthetic material which encloses the edges of a flexible laminate, wherein the synthetic material frame has durable-elastic and flexible consistency and that, into which, a flat band-type through-wiring is formed which runs circumferentially in the immediate vicinity of the frame inner edge on the front side of the laminate and is solidly joined to this.

2. A flexible solar module according to claim 1, wherein, plug-in sockets are applied to the ends of the through-wiring and are formed into the frame.

3. A method for the manufacture of a solar module according to claim 2, the method comprising:
producing a frame according to the RIM-method (reaction injection moulding) where a flexible laminate is placed into the form for establishing the frame;
circumferentially and solidly joining flat band-type through-wirings on its front side; and providing plug-in sockets at the ends.

4. A method for the manufacture of a flexible solar module according to claim 3, wherein the solid connection of the band-type through-wiring at the laminate is effected by means of riveting or cementing, where metal washers can be added to the rivets underneath for the purpose of additional anchoring of the rear-side frame.

5. A flexible solar module according to claim 1, wherein, a flexible and thin panel made of synthetic material or metal is used for the rear-side covering of the laminate.

6. A flexible solar module according to claim 5, wherein, the panel comprises PVC hard foam.

7. A method for the manufacture of a flexible solar module according to claim 5, the method comprising:
fixed-positioning the rear-side panel on the rear side on the laminate before placing the panel into the form for establishing the frame with RIM.

8. A flexible solar module according to claim 1, comprising a layer of weather-proof, closed-porous, soft and durable-elastic foam material used for the rear-side covering of the laminate.

9. A method for the manufacture of a solar module according to claim 8, comprising:
cementing the layer of foam material rear-side on the laminate; and
placing the laminate into the form for establishing the frame with RIM.

10. A flexible solar module according to claim 8, wherein, the thickness of this foam material layer is greater than the thickness of the frame on its underneath side.

11. A flexible solar module according to claim 8, wherein, the foam material is provided on the rear side, either completely or partially, with a self-adhesive layer and is provided at those locations which are self-adhesive with a removable and peelable protective foil.

12. A flexible solar module according to claim 1, wherein, a suitable adhesive agent for point-wise application on the module rear side is co-supplied with the module for the respective roof material.

13. A flexible solar power module according to claim 1, wherein, on the rear side of the frame a circumferential seal comprising durable elastic sealing material is applied.

14. The module of claim 13 wherein the sealing material comprises a round cord made of butyl-caoutschouc with a protective foil that can be removed or peeled on the building side.

15. A flexible solar power module according to claim 14 wherein, a circumferential hollow channel is formed into the frame on the underneath side for accommodating the seal.

16. A flexible solar power module according to claim 11, comprising a seal comprising a butyl round cord with an inserted core, which brings the spacing of the module to the subsurface to a defined size.

17. A flexible solar power module according to claim 1 wherein the frame receives securing holes which, at the corners of the frame at the locations of the overlapping of the band-type through-wiring, have full passage through these and are protected by means of synthetic sockets against weather conditions as well as against unintentional electric contact with fastening screws.

18. A method for the manufacture of a flexible solar module according to claim 17, the method comprising:
before the inclusion of the laminate into the form for establishing the frame with RIM, making the holes for the securing purposes all the way through the laminate and the overlapping of the through-wiring; and
positioning the sockets consisting of insulating synthetic material in the securing holes.

19. A flexible solar power module according to claim 1 wherein, the front side facing the light is covered off with a protective foil in such a way that this, going beyond the laminate, partially covers the frame and uses the frame as an adhesive subsurface.
